(19) United States
(12) Patent Application Publication
(10) Pub. No.: US 2023/0127227 A1
(43) Pub. Date: Apr. 27, 2023

(54) CONTEXT-SPECIFIC ITEM-TO-AGREEMENT MATCHING

(71) Applicant: SAP SE, Walldorf (DE)

(72) Inventors: Shruthi JINADATTA, Bangalore (IN); Shivaprasad KC, Bangalore (IN)

(21) Appl. No.: 17/511,924

(22) Filed: Oct. 27, 2021

(51) Int. Cl. G06Q 30/06

(52) U.S. Cl. CPC G06Q 30/0637; G06Q 30/0619; G06Q 30/0627

(57) ABSTRACT

Systems and methods include identification of a plurality of items, each of the plurality of items associated with a value of each of a plurality of attributes, determination of a first set of matching criteria, the first set of matching criteria comprising a first plurality of the plurality of attributes, identification of an agreement comprising a plurality of agreement items, each of the agreement items associated with a value of each of the plurality of attributes, determination, based on the first set of matching criteria, one or more of the first plurality of items which match at least one agreement item of the agreement, presentation of an indication of the one or more of the first plurality of items which match at least one agreement item of the agreement, reception of an instruction to add one or more of the one or more of the first plurality of items which match at least one agreement item of the agreement to the agreement, and, in response to the instruction, addition of the one or more of the one or more of the first plurality of items which match at least one agreement item of the agreement to the agreement.

### BACKGROUND

Traditional computing system architectures include one or more servers executing applications which access data stored in one or more database systems. Users interact with an application to view, create and update the data in accordance with functionality provided by the application. Within an enterprise, several applications may exchange data with one another in order to execute an end-to-end process based on input received from multiple users.

In one example, a user may operate a sourcing application to create a sourcing event which specifies one or more items to be obtained. The sourcing application may request and receive bids from one or more suppliers, and the user may select a supplier from which to obtain each of the one or more items. Typically, an agreement (e.g., a contract) with each selected supplier is then created (e.g., using another application).

In many instances, one or more agreements with at least one of the selected suppliers may already exist. Moreover, one or more existing agreements may be already associated with a particular item of the sourcing event and a selected supplier from which the item is to be obtained. It would therefore be desirable in some of such instances to add a particular item to an existing agreement rather than to create a new agreement associated with the particular item.

Determination of an agreement to which an item should be added presents many difficulties. For example, both a sourcing event and an agreement may include hundreds or thousands of individual items. Moreover, the attributes associated with identical items (e.g., price, quantity, location, delivery terms) may differ between agreements and sourcing events and even within a same agreement or sourcing event. Accordingly, the selection of appropriate agreements to which each item of a sourcing event should be added is a time-consuming, manual and error-prone task.

Systems are desired to facilitate item-level determination of suitable agreements.

### BRIEF DESCRIPTION OF THE DRAWINGS

FIG. 1 is a block diagram of an architecture to facilitate matching of sourcing event items with agreements according to some embodiments.

FIG. 2 is a representation of a sourcing event according to some embodiments.

FIG. 3 is a flow diagram of a process to facilitate matching of sourcing event items with agreements according to some embodiments.

FIG. 4 is a user interface for initiating matching of sourcing event items with agreements according to some embodiments.

FIG. 5 is a user interface showing results of item-agreement matching according to some embodiments.

FIG. 6 is a user interface for indicating items to add to a matched agreement according to some embodiments.

FIG. 7 is a user interface for configuring criteria used for matching sourcing event items with agreements according to some embodiments.

FIG. 8 is a block diagram of an architecture including enterprise resource planning applications according to some embodiments.

FIG. 9 is a block diagram of a hardware system to match sourcing event items with agreements according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Briefly, some embodiments automatically identify agreements to which a sourcing event item may be added based on pre-defined matching criteria. The matching criteria may identify item attributes on which the identification should be based.

In some embodiments, the matching criteria are customizable. For example, one sourcing organization may wish to identify matching agreements based on a set of matching criteria which are different from and/or have different relative importances (e.g., weights) than those of another sourcing organization.

A ranking of identified agreements may be determined and the identified agreements may be presented to a user based on the ranking. The ranking may reflect a number of matching items as well as a degree to which the matching items satisfy the matching criteria.

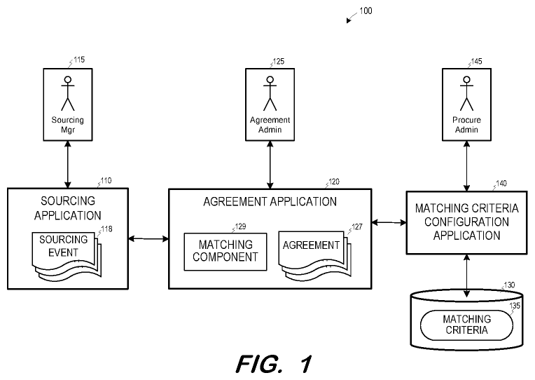

FIG. 1 is a block diagram of an architecture of system 100 according to some embodiments. The illustrated elements of system 100 may be implemented using any suitable combination of computing hardware and/or software that is or becomes known. Such a combination may include implementations which apportion computing resources elastically according to demand, need, price, and/or any other metric. In some embodiments, two or more elements of system 100 are implemented by a single computing device. Two or more elements of system 100 may be co-located. One or more elements of system 100 may be implemented as a cloud service (e.g., Software-as-a-Service, Platform-as-a-Service).

Sourcing application 110 may comprise a software application to allow sourcing manager 115 (or another end-user) to create one or more sourcing events 118. Sourcing application 110 may provide additional functionality to end-users and may be a component of a suite of applications provided by an application provider. Sourcing application 110 may be executed by an application platform comprising an on-premise, cloud-based, or hybrid hardware system providing an execution platform and services to software applications. Such an application platform may comprise one or more virtual machines executing program code of an application server. All software applications described herein may comprise program code executable by one or more processing units (e.g., Central Processing Units (CPUs), processor cores, processor threads) of an application platform to provide various functions.

A sourcing event 118 is created in order to initiate a process to obtain one or more items from one or more suppliers. Each sourcing event 118 includes list of one or more items, each of which is associated with one or more attributes. An item may comprise a good (e.g., a raw material, a product), a service, or any other entity which may be obtained from a supplier. Attributes specified for each item may include, but are not limited to, name, description, quantity, start date, end date, material code, region, etc.

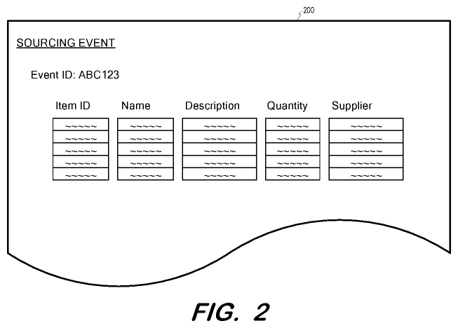

FIG. 2 depicts a sourcing event according to some embodiments. Sourcing event 200 is associated with an Event ID “ABC123”. Sourcing event 200 lists five items, but embodiments are not limited thereto. Each of the five items is associated with respective values for each of five attributes: Item ID, Name, Description, Quantity and Supplier.

The value of the Supplier attribute associated with each item may be determined in any manner that is or becomes known. For one or more of the listed items, sourcing manager 115 may simply specify a particular supplier. For example, sourcing manager 115 may simply select the value of the Supplier attribute for a given item from a drop-down list of potential suppliers. of the given item.

In some embodiments, a sourcing event 118 which does not include values of the Supplier attribute is transmitted to a plurality of suppliers (e.g., via a Business-to-Business procurement system), who in turn submit bids for supplying one or more of the items of the sourcing event 118. The bids are received by sourcing application 110 and presented to sourcing manager 115. Sourcing manager 115 may then select a supplier for each given item based on the bids submitted for the given item. As a result, an identifier of the selected supplier populates the Supplier attribute of the given item.

Returning to FIG. 1, sourcing manager 115 instructs sourcing application 110 to transmit a sourcing event 118 to agreement application 120. Agreement administrator 125 (who may be identical to sourcing manager 115) operates agreement application 120 to associate each item of the transmitted sourcing event 118 with an agreement 127. Each agreement 127 may comprise a contract, for example, which specifies the terms and conditions under which a supplier will provide one or more items. The agreement 127 with which an item is associated may be an existing agreement 127 which is identified as described herein, or an agreement which is newly-created based on the item. It should be noted that functions attributed herein to either sourcing application 110 or agreement application 120 may be performed by a single application.

Matching component 129 of agreement application 120 may comprise program code executable to match each of one or more items of a given sourcing event 118 to one or more of agreements 127. Matching component 129 uses matching criteria 135 to match an item to one or more agreements 127. Matching criteria 135 may specify item attributes to be considered in the matching process, and may associate different item attributes with different weights which are also taken into account. Matching criteria 135 is stored in storage 130, which may comprise any standalone and/or distributed on-premise, cloud-based or hybrid storage available to matching criteria configuration application 140.

Procurement administrator 145 may operate matching criteria configuration application 140 to configure matching criteria 135. Thusly-configured matching criteria may be specific to the organization to which procurement administrator 145 belongs. Accordingly, matching criteria 135 may include several independent sets of organization-specific matching criteria. System 100 may therefore comprise a multi-tenant system in which end-users from different organizations (i.e., tenants) may access each of sourcing application 110, agreement application 120 and matching criteria configuration application 140 and in which, by virtue of known authorization and authentication mechanisms, the sourcing events 118, agreements 127 and matching criteria 135 associated with each tenant are segregated from and inaccessible to each other tenant.

After matching component 129 has identified item-to-agreement matches based on appropriate matching criteria 135, the matches may be presented to agreement administrator 125. In the case of a particular item determined to match one or more agreements, administrator 125 may instruct agreement application 120 to add the item to one of the agreements. As described above, such matching and updating may advantageously facilitate the avoidance of unnecessary creation and proliferation of new agreements.

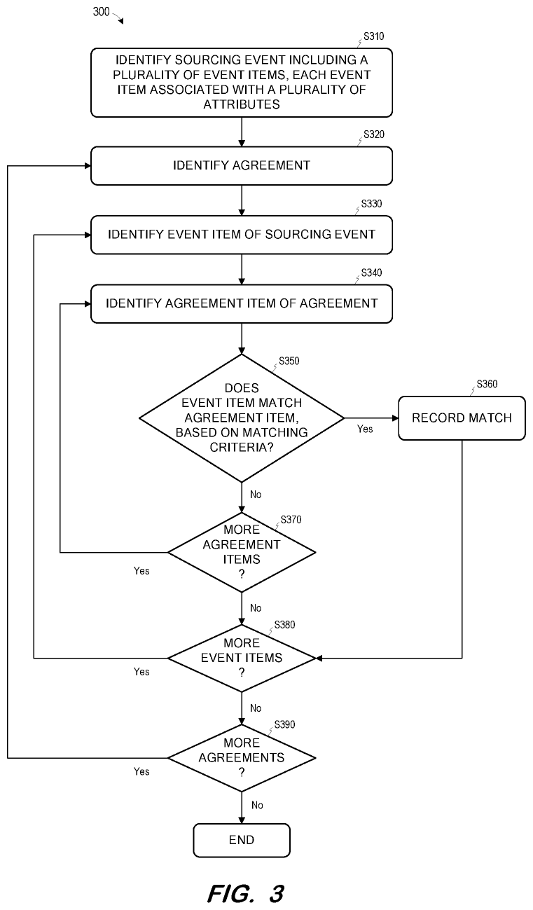

FIG. 3 comprises a flow diagram of process 300 to facilitate matching of sourcing event items with agreements according to some embodiments. Process 300 will be described below as if executed by matching component 129 of agreement application 120, but embodiments are not limited thereto.

Process 300 and all other processes mentioned herein may be embodied in processor-executable program code read from one or more of non-transitory computer-readable media, such as, for example, a hard disk drive, a volatile or non-volatile random access memory, a DVD-ROM, a Flash drive, and a magnetic tape, and then stored in a compressed, uncompiled and/or encrypted format. A processor may include any number of microprocessors, microprocessor cores, processing threads, or the like. In some embodiments, hard-wired circuitry may be used in place of, or in combination with, program code for implementation of processes according to some embodiments. Embodiments are therefore not limited to any specific combination of hardware and software.

Process 300 may be initiated by a request to create an agreement based on a sourcing event. In one example, sourcing manager 115 may operate sourcing application 110 to generate a sourcing event 118 or to select an already-created sourcing event 118. As described above, the generated or selected sourcing event includes one or more items, and each item is associated with values of each of several attributes. Sourcing manager 115 may further operate sourcing application 110 to request creation of an agreement based on the sourcing event 118.

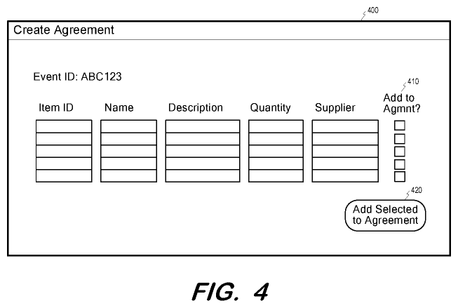

User interface 400 of FIG. 4 is an example of a user interface of sourcing application 110 according to some embodiments. User interface 400 shows items of a sourcing event and their associated attributes. User interface 400 also includes a checkbox 410 adjacent to each item. Each checkbox 410 is selectable to indicate whether the adjacent item should be added to an agreement. Accordingly, a user may select control 420 to issue an instruction to add the selected items to an agreement. In response, a request may be sent to agreement application 120 to identify one or more agreements to which each of the selected items may be added. Based on the request, agreement application 120 may then trigger matching component 129 to execute process 300.

At S310, matching component 129 identifies the sourcing event of the instruction, along with the items to be added to an agreement and their associated attribute values. It should be noted that all of the items are not necessarily associated with a value for each of a same set of attributes. For example, one of the may be associated with a value “U.S.” for the attribute Region while another one of the items is associated with a NULL value for the Region attribute.

Matching component 129 then identifies an agreement at S320. The identified agreement may be selected from all or a subset of agreements 127 accessible to agreement application 120. For example, in the case of a multi-tenant architecture, matching component 129 may determine all agreements 127 associated with a current tenant and identify an agreement at S320 from the determined agreements 127.

Next, at S330, a first item of the sourcing event agreement (i.e., an “event item”) is identified. An item of the identified agreement (i.e., an “agreement item”) is then identified at S340. At S350, it is then determined, based on appropriate matching criteria, whether the item identified at S330 matches the item identified at S340. S350 may therefore include determination of matching criteria from matching criteria 135. The determined matching criteria may comprise matching criteria which is associated with the current tenant.

The determination at S350 may comprise identification of one or more attributes specified by the matching criteria. The values of each of the one or more attributes of the event item and the agreement item are compared and a matching score is generated based on the comparison. For example, if the matching criteria include Name, Description and Region attributes, then the Name value of the event item is compared to the Name value of the agreement item, the Description value of the event item is compared to the Description value of the agreement item, and the Region value of the event item is compared to the Region value of the agreement item. S350 may include any process for comparing pairs of values (e.g., numeric, string, or other) that is or becomes known.

For example, an overall match score may be determined based on the degree to which the value of each attribute is similar to its counterpart value. Determination of a match at S530 may comprise determining whether the overall match score exceeds a threshold. Attributes may be associated with different weights in the determination of the overall match score, such that a close match of values of a heavily-weighted attribute will affect the overall match score to a greater degree than a similarly-close match of values of a lightly-weighted attribute.

Flow proceeds to S360 if it is determined at S350 that the event item and the agreement item match. At S350, the matching items are recorded and a counter of the number of matches within the current agreement is incremented. Next, at S380, it is determined whether additional event items of the sourcing event exist. If so, flow returns to S330 to identify a next event item of the sourcing event.

If no match is determined at S350, it is determined whether the current agreement includes more items at S370. If the determination at S370 is positive, flow returns to S340 to identify a next item of the agreement to be compared to the current event item. If negative, and if it is determined at S380 that no more event items of the sourcing event exist, flow proceeds to S390 to determine if any additional agreements exist. If so, flow returns to S320.

Accordingly, for each event item of a sourcing event, flow cycles between S340, S350, and S370 until it is determined that an agreement item of a current agreement matches the event item or until no agreement items remain to be compared to the event item. This process repeats (by virtue of S320 and S390) for every agreement to be analyzed. At the conclusion of process 300, each match found in each agreement has been recorded, along with a count of the number of matches which were identified in each agreement. Each recorded match may be associated with an overall match score as described above, and an overall agreement score may be determined for a given agreement based on all the overall match scores of the given agreement.

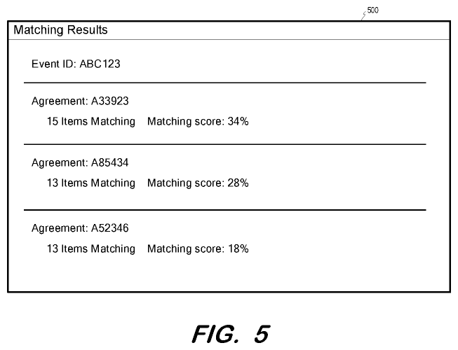

The results of process 300 may be presented to a user such as agreement administrator 125 in any suitable manner. User interface 500 of FIG. 5 is an example user interface depicting matching results associated with Sourcing event “ABC123” and three stored agreements according to some embodiments. For each agreement, user interface 500 indicates a number of event items of Sourcing event “ABC123” which were determined to match an item of the agreement. Each agreement is also associated with a matching score which may be based on the number of matching event items and/or on the degree to which the event items match corresponding agreement items. User interface 500 may be configured to present the agreements in descending order based on the number of matching items, matching score, or a combination thereof

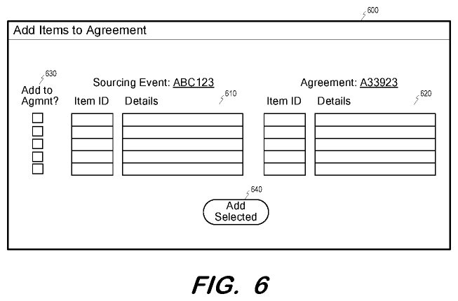

According to some embodiments, an agreement depicted in user interface 500 may be selected in order to allow a user to add the matching event items to the agreement. User interface 600 of FIG. 6, for example, may be presented to a user upon selection of Agreement “A33923” within user interface 500. User interface 600 may facilitate the addition of one or more items of Sourcing event “ABC123” to Agreement “A33923”. Embodiments are not limited to user interfaces 500 and 600.

User interface 600 shows event items 610 of the sourcing event and matching items 620 of the selected agreement. Check boxes 630 allow selection of any of the event items 610 to add to the selected agreement. Any number of attributes of each item may be presented to assist the user in determining whether to add an event item to the selected agreement. Selection of control 640 initiates a process of adding selected event items to the agreement.

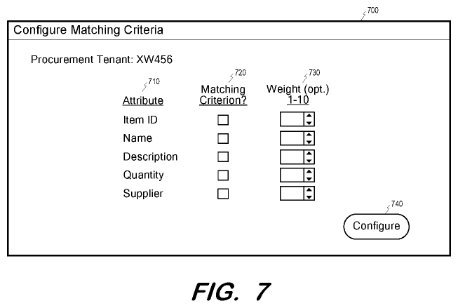

FIG. 7 is a view of user interface 700 according to some embodiments. User interface 700 allows a procurement administrator or any other suitable end-user to configure matching criteria for the determination of matching items as described herein. User interface 700 may comprise a user interface of matching criteria configuration application 140 in some embodiments.

As described, a particular set of matching criteria may be associated with a given tenant, in the illustrated case tenant “XW456”. List 710 includes attributes which may be selected for inclusion into the matching criteria. Checkboxes 720 allow selection of one or more of the attributes of list 710. For each selected attribute, fields 730 allow configuration of an associated weight. The weight determines the relative importance of a given attribute to the determination of whether a match exists. Once checkboxes 720 and optional weights 730 are suitably completed, the user may select Configure control 740 to save the matching criteria in association with the tenant in storage 130 for use as described above.

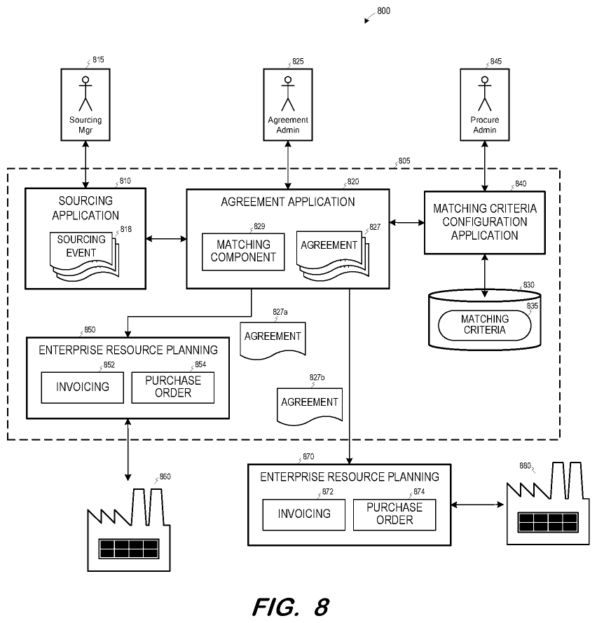

FIG. 8 is a block diagram of architecture 800 including enterprise resource planning applications according to some embodiments. Sourcing application 810, agreement application 820 and matching criteria configuration application 840 may operate as described above with respect to their similarly-named counterparts of architecture 100 to identify agreements 827 to which items of sourcing events 818 may be added. Sourcing application 810, agreement application 820 and matching criteria configuration application 840 may belong to suite 805 of applications to which the organization of sourcing manager 815, agreement administrator 825 and procurement administrator 845 subscribes and which also includes enterprise resource planning application 850.

Enterprise resource planning application 850 may receive an agreement 827a from agreement application 820. Agreement 827a may comprise an agreement which was previously created (e.g., based on a sourcing event 818) and to which one or more items from a subsequent sourcing event 818 may have been added as described herein. Enterprise resource planning application 850 is configured to receive agreement 827a and generate a purchase order (using purchase order component 854) and an invoice (using invoicing component 852) for transmission to supplier 860. In such a scenario, supplier 860 is itself a tenant of suite 805 and therefore may receive the purchase order and invoice directly from enterprise resource planning application 850.

In contrast, supplier 880 is not a tenant of suite 805. Supplier 880 uses its own enterprise resource planning application 870, including purchase order component 874 and invoicing component 872. As shown, enterprise resource planning application 870 may receive agreement 827b from agreement application 820. Agreement 827b may include items from a same sourcing event 818 as items of agreement 827a, but embodiments are not limited thereto. Enterprise resource planning application 870 is generates a purchase order and an invoice based on agreement 827b and provides the purchase order and the invoice to supplier 880.

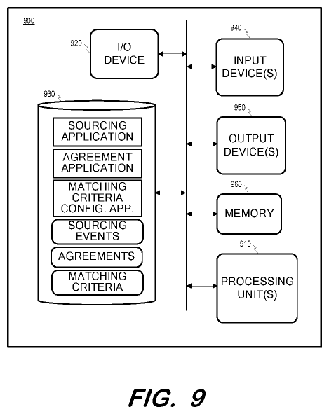

FIG. 9 is a block diagram of a hardware system hardware system to match sourcing event items with agreements according to some embodiments. Hardware system 900 may comprise a general-purpose computing apparatus and may execute program code to perform any of the functions described herein. Hardware system 900 may be implemented by a distributed cloud-based server and may comprise an implementation of application suite 805 in some embodiments. Hardware system 900 may include other unshown elements according to some embodiments.

Hardware system 900 includes processing unit(s) 910 operatively coupled to I/O device 920, data storage device 930, one or more input devices 940, one or more output devices 950 and memory 960. Communication device 920 may facilitate communication with external devices, such as an external network, the cloud, or a data storage device. Input device(s) 940 may comprise, for example, a keyboard, a keypad, a mouse or other pointing device, a microphone, knob or a switch, an infra-red (IR) port, a docking station, and/or a touch screen. Input device(s) 940 may be used, for example, to enter information into hardware system 900. Output device(s) 950 may comprise, for example, a display (e.g., a display screen) a speaker, and/or a printer.

Data storage device 930 may comprise any appropriate persistent storage device, including combinations of magnetic storage devices (e.g., magnetic tape, hard disk drives and flash memory), optical storage devices, Read Only Memory (ROM) devices, and RAM devices, while memory 960 may comprise a RAM device.

Data storage device 930 stores program code executed by processing unit(s) 910 to cause server 900 to implement any of the components and execute any one or more of the processes described herein. Embodiments are not limited to execution of these processes by a single computing device. Data storage device 930 may also store data and other program code for providing additional functionality and/or which are necessary for operation of hardware system 900, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
at least one programmable processor; and
a non-transitory machine-readable medium storing instructions that, when executed by the at least one programmable processor, cause the at least one programmable processor to perform operations comprising:
identifying a plurality of items, each of the plurality of items associated with a value of each of a plurality of attributes;
determining a first set of matching criteria, the first set of matching criteria comprising a first plurality of the plurality of attributes;
identifying an agreement comprising a plurality of agreement items, each of the agreement items associated with a value of each of the plurality of attributes;
determining, based on the first set of matching criteria, one or more of the first plurality of items which match at least one agreement item of the agreement;
presenting an indication of the one or more of the first plurality of items which match at least one agreement item of the agreement;
receiving an instruction to add one or more of the one or more of the first plurality of items which match at least one agreement item of the agreement to the agreement; and
in response to the instruction, adding the one or more of the one or more of the first plurality of items which match at least one agreement item of the agreement to the agreement.

2. A system according to claim 1, wherein the instructions, when executed by the at least one programmable processor, cause the at least one programmable processor to perform operations comprising:
identifying a second agreement comprising a second plurality of agreement items, each of the second plurality of agreement items associated with a value of each of the plurality of attributes;
determining, based on the first set of matching criteria, one or more of the first plurality of items which match at least one of the second plurality of agreement items; and
presenting a second indication of the one or more of the first plurality of items which match at least one of the second plurality of agreement items.

3. A system according to claim 2, wherein the instructions, when executed by the at least one programmable processor, cause the at least one programmable processor to perform operations comprising:
receiving a second instruction to add one or more of the one or more of the first plurality of items which match at least one of the second plurality of agreement items to the second agreement; and
in response to the second instruction, adding the one or more of the one or more of the first plurality of items which match at least one of the second plurality of agreement items to the second agreement.

4. A system according to claim 2, wherein determining one or more of the first plurality of items which match at least one agreement item of the agreement comprises determining a first matching score,
wherein determining, based on the first set of matching criteria, one or more of the first plurality of items which match at least one of the second plurality of agreement items comprises determining a second matching score, and
wherein the indication and the second indication are presented in an order based on the first matching score and the second matching score.

5. A system according to claim 1, wherein determining the first set of matching criteria comprises determining a tenant associated with the plurality of items and determining that the first set of matching criteria is associated with the tenant.

6. A system according to claim 1, wherein the instructions, when executed by the at least one programmable processor, cause the at least one programmable processor to perform operations comprising:
identifying a second plurality of items, each of the second plurality of items associated with a value of each of a plurality of attributes;
determining a second set of matching criteria, the second set of matching criteria comprising a second plurality of the plurality of attributes;
identifying a second agreement comprising a second plurality of agreement items, each of the second agreement items associated with a value of each of the plurality of attributes;
determining, based on the second set of matching criteria, one or more of the second plurality of items which match at least one agreement item of the second agreement;
presenting a second indication of the one or more of the second plurality of items which match at least one agreement item of the second agreement;
receiving a second instruction to add one or more of the one or more of the second plurality of items which match at least one agreement item of the second agreement to the second agreement; and
in response to the second instruction, adding the one or more of the one or more of the second plurality of items which match at least one agreement item of the second agreement to the second agreement.

7. A system according to claim 6, wherein determining the first set of matching criteria comprises determining a tenant associated with the plurality of items and determining that the first set of matching criteria is associated with the tenant, and
wherein determining the second set of matching criteria comprises determining a second tenant associated with the second plurality of items and determining that the second set of matching criteria is associated with the second tenant.

8. A method comprising:
identifying a plurality of items, each of the plurality of items associated with a value of each of a plurality of attributes;
determining a first set of matching criteria, the first set of matching criteria comprising a first plurality of the plurality of attributes;
identifying an agreement comprising a plurality of agreement items, each of the agreement items associated with a value of each of the plurality of attributes;
determining, based on the first set of matching criteria, one or more of the first plurality of items which match at least one agreement item of the agreement;
presenting an indication of the one or more of the first plurality of items which match at least one agreement item of the agreement;
receiving an instruction to add one or more of the one or more of the first plurality of items which match at least one agreement item of the agreement to the agreement; and
in response to the instruction, adding the one or more of the one or more of the first plurality of items which match at least one agreement item of the agreement to the agreement.

9. A method according to claim 8, further comprising:
identifying a second agreement comprising a second plurality of agreement items, each of the second plurality of agreement items associated with a value of each of the plurality of attributes;
determining, based on the first set of matching criteria, one or more of the first plurality of items which match at least one of the second plurality of agreement items; and
presenting a second indication of the one or more of the first plurality of items which match at least one of the second plurality of agreement items.

10. A method according to claim 9, further comprising:
receiving a second instruction to add one or more of the one or more of the first plurality of items which match at least one of the second plurality of agreement items to the second agreement; and
in response to the second instruction, adding the one or more of the one or more of the first plurality of items which match at least one of the second plurality of agreement items to the second agreement.

11. A method according to claim 9, wherein determining one or more of the first plurality of items which match at least one agreement item of the agreement comprises determining a first matching score,
wherein determining, based on the first set of matching criteria, one or more of the first plurality of items which match at least one of the second plurality of agreement items comprises determining a second matching score, and
wherein the indication and the second indication are presented in an order based on the first matching score and the second matching score.

12. A method according to claim 8, wherein determining the first set of matching criteria comprises determining a tenant associated with the plurality of items and determining that the first set of matching criteria is associated with the tenant.

13. A method according to claim 8, further comprising:
identifying a second plurality of items, each of the second plurality of items associated with a value of each of a plurality of attributes;
determining a second set of matching criteria, the second set of matching criteria comprising a second plurality of the plurality of attributes;
identifying a second agreement comprising a second plurality of agreement items, each of the second agreement items associated with a value of each of the plurality of attributes;
determining, based on the second set of matching criteria, one or more of the second plurality of items which match at least one agreement item of the second agreement;
presenting a second indication of the one or more of the second plurality of items which match at least one agreement item of the second agreement;
receiving a second instruction to add one or more of the one or more of the second plurality of items which match at least one agreement item of the second agreement to the second agreement; and
in response to the second instruction, adding the one or more of the one or more of the second plurality of items which match at least one agreement item of the second agreement to the second agreement.

14. A method according to claim 13, wherein determining the first set of matching criteria comprises determining a tenant associated with the plurality of items and determining that the first set of matching criteria is associated with the tenant, and
wherein determining the second set of matching criteria comprises determining a second tenant associated with the second plurality of items and determining that the second set of matching criteria is associated with the second tenant.

15. A non-transitory medium storing processor-executable program code executable by a processing unit of a computing system to cause the computing system to:
identify a plurality of items, each of the plurality of items associated with a value of each of a plurality of attributes;
determine a first set of matching criteria, the first set of matching criteria comprising a first plurality of the plurality of attributes;
identify an agreement comprising a plurality of agreement items, each of the agreement items associated with a value of each of the plurality of attributes;
determine, based on the first set of matching criteria, one or more of the first plurality of items which match at least one agreement item of the agreement;
present an indication of the one or more of the first plurality of items which match at least one agreement item of the agreement;
receive an instruction to add one or more of the one or more of the first plurality of items which match at least one agreement item of the agreement to the agreement; and
in response to the instruction, add the one or more of the one or more of the first plurality of items which match at least one agreement item of the agreement to the agreement.

16. A medium according to claim 15, the processor-executable program code executable by a processing unit of a computing system to cause the computing system to:
identify a second agreement comprising a second plurality of agreement items, each of the second plurality of agreement items associated with a value of each of the plurality of attributes;
determine, based on the first set of matching criteria, one or more of the first plurality of items which match at least one of the second plurality of agreement items; and
present a second indication of the one or more of the first plurality of items which match at least one of the second plurality of agreement items.

17. A medium according to claim 16, the processor-executable program code executable by a processing unit of a computing system to cause the computing system to:
receive a second instruction to add one or more of the one or more of the first plurality of items which match at least one of the second plurality of agreement items to the second agreement; and
in response to the second instruction, add the one or more of the one or more of the first plurality of items which match at least one of the second plurality of agreement items to the second agreement.

18. A medium according to claim 16, wherein determination of one or more of the first plurality of items which match at least one agreement item of the agreement comprises determination of a first matching score,
wherein determination, based on the first set of matching criteria, of one or more of the first plurality of items which match at least one of the second plurality of agreement items comprises determination of a second matching score, and
wherein the indication and the second indication are presented in an order based on the first matching score and the second matching score.

19. A medium according to claim 15, wherein determination of the first set of matching criteria comprises determination of a tenant associated with the plurality of items and determining that the first set of matching criteria is associated with the tenant.

20. A medium according to claim 15, the processor-executable program code executable by a processing unit of a computing system to cause the computing system to:
identify a second plurality of items, each of the second plurality of items associated with a value of each of a plurality of attributes;
determine a second set of matching criteria, the second set of matching criteria comprising a second plurality of the plurality of attributes;
identify a second agreement comprising a second plurality of agreement items, each of the second agreement items associated with a value of each of the plurality of attributes;
determine, based on the second set of matching criteria, one or more of the second plurality of items which match at least one agreement item of the second agreement;
present a second indication of the one or more of the second plurality of items which match at least one agreement item of the second agreement;
receive a second instruction to add one or more of the one or more of the second plurality of items which match at least one agreement item of the second agreement to the second agreement; and
in response to the second instruction, add the one or more of the one or more of the second plurality of items which match at least one agreement item of the second agreement to the second agreement,
wherein determination of the first set of matching criteria comprises determination of a tenant associated with the plurality of items and determining that the first set of matching criteria is associated with the tenant, and
wherein determination of the second set of matching criteria comprises determination of a second tenant associated with the second plurality of items and determining that the second set of matching criteria is associated with the second tenant.
